(19) United States
(12) Patent Application Publication
(10) Pub. No.: US 2009/0266966 A1
(43) Pub. Date: Oct. 29, 2009

(54) Position Retention Device for Retaining Projector Folding Mirror

(75) Inventor: Greg Sample, Newberg, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: INFOCUS CORPORATION, Wilsonville, OR (US)

(21) Appl. No.: 12/109,207

(22) Filed: Apr. 24, 2008

(51) Int. Cl. A47G 1/17; B23P 19/04

(52) U.S. Cl. 248/467; 29/700

(57) ABSTRACT

Position retention devices and methods for aligning and retaining a folding mirror assembly to a docking structure of a projector of a display system are provided herein. An example of such devices includes an adhesive backed retention pad having an adhesive surface configured to bond with the folding mirror assembly, and an alignment screw configured to fasten the folding mirror assembly to the docking structure by threading through the docking structure and into the adhesive backed retention pad, the adhesive backed retention pad retaining the alignment screw via a compression force. An example of such methods includes adhering an adhesive backed retention pad to the folding mirror assembly, the adhesive backed retention pad having an adhesive surface configured to bond with the folding mirror assembly, and fastening the folding mirror assembly to the docking structure by threading an alignment screw through the docking structure and into the adhesive backed retention pad, the adhesive backed retention pad retaining the alignment screw via a compression force.

### BACKGROUND

A projector of a display system often includes one or more folding mirrors for changing traveling direction of an illuminating light. These folding mirrors often must be aligned and retained at precise angles.

Currently, folding mirrors are mounted onto mirror mounts. Alignment screws are used to adjust the alignment angles of the folding mirrors and to secure the folding mirrors at the desired alignment position and angle. The mirror mounts often include arms or extensions to which the alignment screws may attach. These extra parts may take up valuable space inside a cramped projector compartment and make it difficult to assemble the projectors.

### SUMMARY

Position retention devices and methods for aligning and retaining a folding mirror assembly to a docking structure of a projector of a display system are provided herein. An example of such devices includes an adhesive backed retention pad having an adhesive surface configured to bond with the folding mirror assembly, and an alignment screw configured to fasten the folding mirror assembly to the docking structure by threading through the docking structure and into the adhesive backed retention pad, the adhesive backed retention pad retaining the alignment screw via a compression force. An example of such methods includes adhering an adhesive backed retention pad to the folding mirror assembly, the adhesive backed retention pad having an adhesive surface configured to bond with the folding mirror assembly, and fastening the folding mirror assembly to the docking structure by threading an alignment screw through the docking structure and into the adhesive backed retention pad, the adhesive backed retention pad retaining the alignment screw via a compression force.

### BRIEF DESCRIPTION OF THE DRAWINGS

FIG. 1 is an exploded view of a position retention device for retaining a folding mirror assembly to a projector of a display system.

FIG. 2 is a perspective view of the position retention device of FIG. 1.

FIG. 3 is a cross sectional view of the position retention device of FIG. 2.

FIG. 4 is a flow chart illustrating a method of retaining a folding mirror assembly to a docking structure of a projector using the position retention device of FIG. 1.

### DETAILED DESCRIPTION

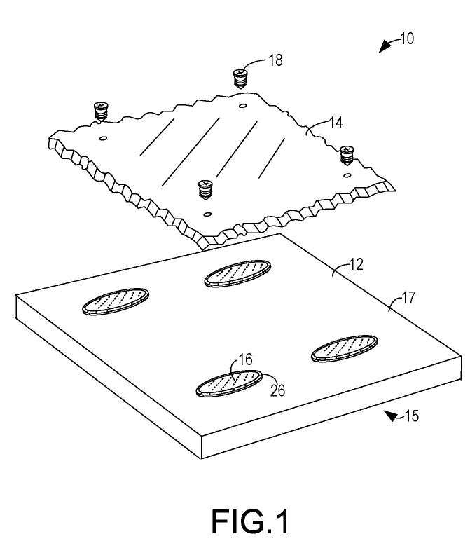

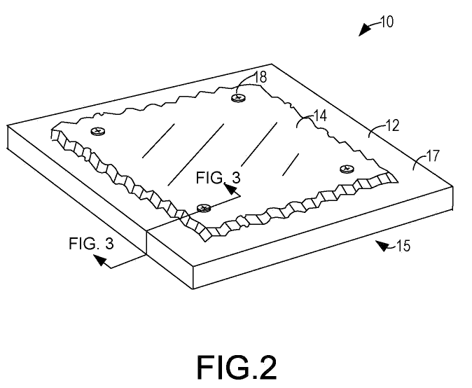

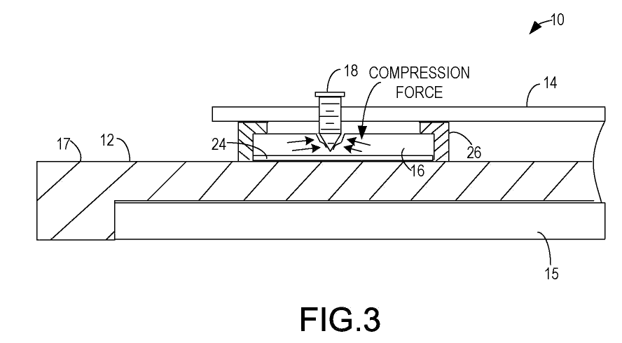

FIGS. 1-3 provide various views of a position retention device 10 for retaining a folding mirror assembly 12 to a docking structure 14 of a projector of a display system. The folding mirror assembly 12 may include a folding mirror 15 mounted onto a folding mirror mount 17.

The position retention device 10 may include one or more adhesive backed retention pads 16, each of which includes an adhesive surface 24 configured to bond with the folding mirror assembly 12, and one or more alignment screws 18, each of which being configured to fasten the folding mirror assembly 12 to the docking structure 14 by threading through the docking structure 14 and into a corresponding adhesive backed retention pad 16, where the corresponding adhesive back retention pad 16 retains the alignment screw 18 via a compression force.

The adhesive backed retention pad 16 may be substantially flat and may be die cut. The adhesive backed retention pad 16 may include an adhesive backed elastomeric pad including an elastomeric material, such as an elastomeric pad having shore durometer hardness in the range of 20 to 70. In one particular example, the adhesive backed retention pad 16 may include an adhesive backed rubber pad. In another particular example, the adhesive backed retention pad 16 may include a liquid adhesive that is cured to the shore durometer hardness in the range of 20 to 70.

The alignment screw 18 may be sized for variable extension through the docking structure 14. A position of the folding mirror assembly 12 relative to the docking structure 14 may be adjusted by changing extension of the alignment screw 18 through the docking structure 14.

Position retention device 10 may include a raised rib 26 configured to further secure the adhesive backed retention pad 16 to the folding mirror assembly 12, in addition to the adhesive force provided by bonding of the adhesive surface 24. The raised rib 26 may extend over or cover a portion, such as a perimeter, of the adhesive backed retention pad 16. The raised rib 26 may be bonded to the folding mirror assembly 12, by a high strength bonding material, for example. Alternatively, the raised rib 26 may be welded to the folding mirror assembly 12 after the adhesive backed retention pad 16 is adhered to the folding mirror assembly 12. As a further alternative, the raised rib 26 may form an integral part of the folding mirror assembly 12.

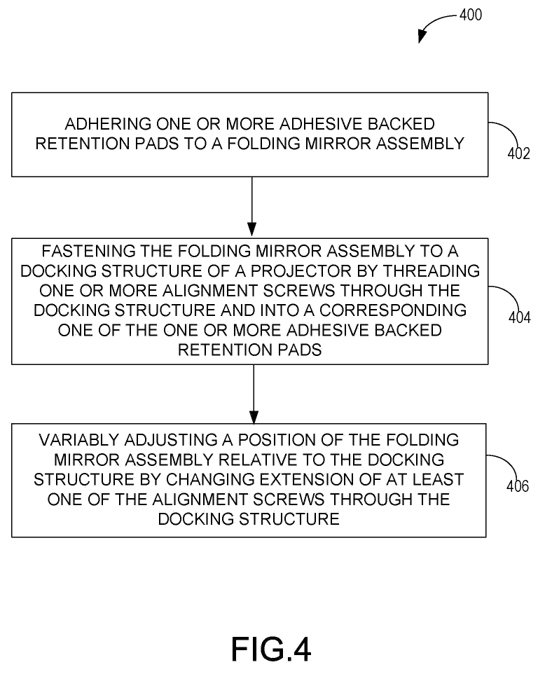

FIG. 4 is a flowchart of an example method 400 for retaining a folding mirror mount to a docking structure of a projector of a display system, for example using position retention device 10 of FIG. 1. The method 400 may include at 402, adhering one or more adhesive backed retention pads having an adhesive surface configured to bond with the folding mirror assembly.

In some embodiments, the method may further include integrating a raised rib to the adhesive backed retention pad, so that at least a portion of the adhesive backed retention pad is covered by the rib. This may include integrally forming the raised rib as part of the adhesive backed retention pad 16.

At 404, method 400 may include fastening the folding mirror assembly to a docking structure of a projector by threading one or more alignment screws through the docking structure and into a corresponding adhesive backed retention pad adhered to the folding mirror assembly. The corresponding adhesive backed retention pad may retain the alignment screw via a compression force.

At 406, the method 400 may include variably adjusting a position of the folding mirror assembly, such as an alignment angle, relative to the docking structure by changing extension of at least one of the one or more alignment screws through the docking structure.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A position retention device for aligning and retaining a folding mirror assembly to a docking structure of a projector, the position retention device comprising:
an adhesive backed retention pad having an adhesive surface configured to bond with the folding mirror assembly; and
an alignment screw configured to fasten the folding mirror assembly to the docking structure by threading through the docking structure and into the adhesive backed retention pad, the adhesive backed retention pad retaining the alignment screw via a compression force.

2. The position retention device of claim 1, wherein the alignment screw is sized for variable extension through the docking structure, and wherein a position of the folding mirror assembly relative to the docking structure is adjustable by changing extension of the alignment screw through the docking structure.

3. The position retention device of claim 1, wherein the adhesive backed retention pad includes an adhesive backed elastomeric pad.

4. The position retention device of claim 3, wherein the adhesive backed retention pad has shore durometer hardness in the range of 20 to 70.

5. The position retention device of claim 1, wherein the adhesive backed retention pad includes an adhesive backed rubber pad.

6. The position retention device of claim 1, wherein the adhesive backed retention pad includes a liquid adhesive that is cured to shore durometer hardness in the range of 20 to 70.

7. The position retention device of claim 1, further comprising a raised rib covering at least a perimeter of the adhesive backed retention pad as it is attached to the folding mirror assembly.

8. The position retention device of claim 1, wherein the adhesive backed pad is one of a plurality of adhesive backed pads configured to bond with the folding mirror assembly, and wherein the alignment screw is one of a plurality of alignment screws, each alignment screw configured to fasten the folding mirror assembly to the docking structure by threading through the docking structure and into the adhesive backed retention pad, the adhesive backed retention pad retaining each alignment screw.

9. A method for aligning and retaining a folding mirror assembly to a docking structure of a projector of a display system, comprising:
adhering an adhesive backed retention pad to the folding mirror assembly, the adhesive backed retention pad having an adhesive surface configured to bond with the folding mirror assembly; and
fastening the folding mirror assembly to the docking structure by threading an alignment screw through the docking structure and into the adhesive backed retention pad, the adhesive backed retention pad retaining the alignment screw via a compression force.

10. The method of claim 9, further comprising variably adjusting the position of the folding mirror assembly relative to the docking structure by changing extension of the alignment screw through the docking structure.

11. The method of claim 9, wherein the adhesive backed retention pad includes an adhesive backed elastomeric pad.

12. The method of claim 10, wherein the adhesive backed retention pad includes an adhesive backed rubber pad.

13. The method of claim 10, wherein the adhesive backed retention pad includes a liquid adhesive cured to shore durometer hardness in the range of 20 to 70.

14. The method of claim 9, further comprising integrating a raised rib to the adhesive backed retention pad, so that at least a portion of the adhesive backed retention pad is covered by the rib.

15. The method of claim 9, further comprising:
adhering one or more additional adhesive backed retention pads to the folding mirror assembly; and
fastening the folding mirror assembly to the docking structure by threading one or more additional alignment screws through the docking structure and into corresponding adhesive backed retention pads, the corresponding adhesive backed retention pads retaining the alignment screws via a compression force.
